(19) United States
(12) Patent Application Publication
(10) Pub. No.: US 2022/0136515 A1
(43) Pub. Date: May 5, 2022

(54) PORTABLE PERSON TRACKING FAN SYSTEM, PROCESS, AND METHOD OF USE

(71) Applicant: Following Fan LLC, Minneapolis, MN (US)

(72) Inventors: Nathan Oelke, Minneapolis, MN (US); Jonathan Cabak, Minneapolis, MN (US)

(21) Appl. No.: 17/517,904

(22) Filed: Nov. 3, 2021

Related U.S. Application Data
(60) Provisional application No. 63/109,350, filed on Nov. 4, 2020.

(51) Int. Cl. F04D 27/00; F04D 19/00; F04D 29/52; F04D 29/053; F04D 25/06; G06K 9/00; G06T 7/20; H04N 5/225; G05B 13/02

(52) U.S. Cl. CPC F04D 27/00; F04D 19/002; F04D 29/522; F04D 29/053; G06F 3/04847; G06K 9/00362; G06T 7/20; H04N 5/2257; G05B 13/0265; F04D 25/0673

(57) ABSTRACT

A portable person tracking fan system, process, and methods of use are presented. More specifically, and without limitation, the present disclosure provides the state of the art with a portable person tracking fan using a camera and machine learning. More specifically, and without limitation, the present disclosure provides the state of the art with a tracking fan system which utilizes computer vision and machine learning to cause a fan to track a user in a desired way. More specifically, and without limitation, the present disclosure provides the state of the art with an easy to set up, and easy to use, airflow cooling system for a user or users, while allowing a user or users to move about freely while the fan tracks and oscillates, via person detection, and/or moves with a user and/or users.

### CROSS-REFERENCE TO RELATED APPLICATIONS

The present application claims priority to the U.S. Provisional Patent Application No. 63/109,350 which was filed on Nov. 4, 2020, which is hereby incorporated by reference herein in its entirety, including any figures, tables, or drawings.

### FIELD OF THE DISCLOSURE

This disclosure relates to a portable person tracking fan system, process, and method of use. More specifically, and without limitation, the present disclosure relates to a portable person tracking fan using a camera and machine learning. More specifically, and without limitation, the present disclosure relates to a tracking fan system which utilizes computer vision and machine learning to cause a fan to track a user in a desired way. More specifically, and without limitation, the present disclosure relates to cooling a user or users, while allowing a user or users to move about freely while the fan tracks and oscillates, via person detection, and/or moves with a user and/or users.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright Following Fan LLC. All rights reserved.

### BACKGROUND OF THE DISCLOSURE

Fans, and particularly powered fan machines, are old and well known in the art. Generally speaking, a fan utilizes a power source and generates an air flow. For a fan, or personal fan, the fan can be used to produce an airflow. This airflow is generally produced by spinning fins or blades around a center point or axis. The spinning blades (also known as vanes) are generally angled in some way and act with force to move air.

In this way, the blades and/or vanes rotate around a central hub. Typically, the hub is a central housing with a motor. The central housing with the motor may have varying speeds and in most cases utilizes electrical power to cause the blades and/or fans to rotate around the center. In this way, the fan converts electrical energy into mechanical energy and causes airflow and/or air movement.

Air flow and/or air movement can cause cooling and/or freshness in a space. This aids in climate control of a space, whether indoor or outdoor. In some ways, when air is moved through a space, it causes fresh air to enter a space. This aids in the reduction of heat in some cases. Furthermore, this aids in entering outside air into a space. Furthermore, this often causes air to move more swiftly over the surface of the skin of a user, which can have a cooling effect and cause comfort for those near or in front of the fan.

The cooling and comfort effects of fans is often desired. Oscillating fans are also old and well known in the art. An oscillating fan is a fan which is designed to rotate from side to side to cause air movement in a variety of directions at certain intervals. This air movement and oscillation can be desired in a space to keep air movement throughout a space, but also to cause air to move across various users at various intervals. In such a way, the fan does not stay constant in the general direction for which it is causing air flow.

Fans, with the exception of the introduction to power, causing former mechanical or human powered fans to become powered, have remained largely unchanged for perhaps thousands of years. Only a few modifications to fans are known over the millennia. These modifications include the introduction of different power sources, mainly electrical power sources, and the introduction of oscillation, such that a fan will rotate back and forth in an arch to provide air flow throughout a space or area at intervals. Furthermore, fans have been integrated as stationary features of some other technologies, such as jet engines, cooling towers, air conditioning units, and similar cooling devices.

Modern fans can be effective at keeping a user cool if the user doesn't move. So if a user is sitting at a table eating, or the like, a fan may be effective. Fan position can be adjusted manually for such occasions. However, if a person moves, a fan can immediately become ineffective. A person in a workshop, such as a hot work shop, would benefit from a fan which could track the user. Oscillating fans fail to track a user but instead only rotate and/or partially rotate at fixed time intervals.

Thus, there is a long-felt need in the art for an effective fan with human tracking capabilities. Furthermore, there is a need in the art for a human tracking fan with portability. Furthermore, there is a need in the art for a fan which effectively and robustly can track a user without a user needing to constantly adjust or get distracted from other activities. Furthermore, there is a need in the art for a fan which can track a user without any secondary devices (which might have to be worn or could be cumbersome). Furthermore, there is a need in the art for a human tracking fan which works in various environments, such as environments of different size, geometry, temperatures, and the like. Furthermore, there is a need in the art for a tracking fan which is easy to set up and use.

The disclosure herein provides these advantages and others as will become clear from the specification and claims provided.

### SUMMARY OF THE DISCLOSURE

A portable person tracking fan system, process, and methods of use are presented. More specifically, and without limitation, the present disclosure provides the state of the art with a portable person tracking fan using a camera and machine learning. More specifically, and without limitation, the present disclosure provides the state of the art with a tracking fan system which utilizes computer vision and machine learning to cause a fan to track a user in a desired way. More specifically, and without limitation, the present disclosure provides the state of the art with an easy to set up, and easy to use, airflow cooling system for a user or users, while allowing a user or users to move about freely while the fan tracks and oscillates, via person detection, and/or moves with a user and/or users.

Thus, it is a primary object of the disclosure to provide a portable person tracking fan system, process, and methods of use that improves upon the state of the art.

Another object of the disclosure is to provide a portable person tracking fan system, process, and methods of use that tracks and follows a user.

Yet another object of the disclosure is to provide a portable person tracking fan system, process, and methods of use that utilizes a camera.

Another object of the disclosure is to provide a portable person tracking fan system, process, and methods of use that utilizes machine learning.

Yet another object of the disclosure is to provide a portable person tracking fan system, process, and methods of use that is portable.

Another object of the disclosure is to provide a portable person tracking fan system, process, and methods of use that keeps a person cool.

Yet another object of the disclosure is to provide a portable person tracking fan system, process, and methods of use that can differentiate between body heat and other objects of similar temperature.

Another object of the disclosure is to provide a portable person tracking fan system, process, and methods of use that can track a user without a secondary device.

Yet another object of the disclosure is to provide a portable person tracking fan system, process, and methods of use that can track a user without the user carrying a secondary device.

Another object of the disclosure is to provide a portable person tracking fan system, process, and methods of use that reliably detects and tracks a user.

Yet another object of the disclosure is to provide a portable person tracking fan system, process, and methods of use that works in environments of varying temperatures.

Another object of the disclosure is to provide a portable person tracking fan system, process, and methods of use that works in environments of varying sizes.

Yet another object of the disclosure is to provide a portable person tracking fan system, process, and methods of use that works in environments of varying geometries.

Another object of the disclosure is to provide a portable person tracking fan system, process, and methods of use that is easy to set up.

Yet another object of the disclosure is to provide a portable person tracking fan system, process, and methods of use that is easy to use.

Another object of the disclosure is to provide a portable person tracking fan system, process, and methods of use that can run autonomously.

Yet another object of the disclosure is to provide a portable person tracking fan system, process, and methods of use that tracks historical data.

Another object of the disclosure is to provide a portable person tracking fan system, process, and methods of use that can be implemented as a retrofit system.

Yet another object of the disclosure is to provide a portable person tracking fan system, process, and methods of use that can track a user horizontally across a space.

Another object of the disclosure is to provide a portable person tracking fan system, process, and methods of use that can track a user vertically across a space.

Yet another object of the disclosure is to provide a portable person tracking fan system, process, and methods of use that executes code in real time to a drive motor.

Another object of the disclosure is to provide a portable person tracking fan system, process, and methods of use that receives and processes data from a camera.

Yet another object of the disclosure is to provide a portable person tracking fan system, process, and methods of use that utilizes object detection.

Another object of the disclosure is to provide a portable person tracking fan system, process, and methods of use that incorporates object detection into a machine learning model.

Yet another object of the disclosure is to provide a portable person tracking fan system, process, and methods of use that detects the location of a user in video frames.

Another object of the disclosure is to provide a portable person tracking fan system, process, and methods of use that can predict user movement by speed and direction.

Yet another object of the disclosure is to provide a portable person tracking fan system, process, and methods of use that processes input to determine how the fan should move and sends data related to fan movement.

Another object of the disclosure is to provide a portable person tracking fan system, process, and methods of use that determines the limit to range of motion.

Yet another object of the disclosure is to provide a portable person tracking fan system, process, and methods of use that provides alerts related to limits to range of motion.

Another object of the disclosure is to provide a portable person tracking fan system, process, and methods of use that provides variable speeds.

Yet another object of the disclosure is to provide a portable person tracking fan system, process, and methods of use that provides variation in movement types.

Another object of the disclosure is to provide a portable person tracking fan system, process, and methods of use that executes a person tracking machine learning set of rules.

Yet another object of the disclosure is to provide a portable person tracking fan system, process, and methods of use that executes a predetermined set of rules.

Another object of the disclosure is to provide a portable person tracking fan system, process, and methods of use that re-writes a predetermined set of rules based on data received and processed.

Yet another object of the disclosure is to provide a portable person tracking fan system, process, and methods of use that detects a user's location.

Another object of the disclosure is to provide a portable person tracking fan system, process, and methods of use that provides a user's distance from the fan.

Yet another object of the disclosure is to provide a portable person tracking fan system, process, and methods of use that increases or decreases fan speed based on a user's distance.

Another object of the disclosure is to provide a portable person tracking fan system, process, and methods of use that reads the gesture of a user and takes actions based on the gesture of a user.

Yet another object of the disclosure is to provide a portable person tracking fan system, process, and methods of use that provides for voice command and voice recognition.

Another object of the disclosure is to provide a portable person tracking fan system, process, and methods of use that provides for pairing with a smart device.

Yet another object of the disclosure is to provide a portable person tracking fan system, process, and methods of use that provides for variation in user tracking.

Another object of the disclosure is to provide a portable person tracking fan system, process, and methods of use that tracks the first user identified.

Yet another object of the disclosure is to provide a portable person tracking fan system, process, and methods of use that provides for tracking of various users based on various parameters.

Another object of the disclosure is to provide a portable person tracking fan system, process, and methods of use that provides for tracking multiple users.

Yet another object of the disclosure is to provide a portable person tracking fan system, process, and methods of use that provides for tracking multiple users based on various parameters and various methods.

Another object of the disclosure is to provide a portable person tracking fan system, process, and methods of use that provides alerts.

Yet another object of the disclosure is to provide a portable person tracking fan system, process, and methods of use that can disengage or deactivate in event that user communication is lost.

Another object of the disclosure is to provide a portable person tracking fan system, process, and methods of use that can re-engage and/or reactivate in the event that user communication is regained.

Yet another object of the disclosure is to provide a portable person tracking fan system, process, and methods of use that provides for energy conservation by activation and deactivation only when a user is in a space or within certain parameters.

Another object of the disclosure is to provide a portable person tracking fan system, process, and methods of use that can utilize global positioning systems.

Yet another object of the disclosure is to provide a portable person tracking fan system, process, and methods of use that can utilize a global positioning system for localized weather information.

Another object of the disclosure is to provide a portable person tracking fan system, process, and methods of use that is easy to use.

Yet another object of the disclosure is to provide a portable person tracking fan system, process, and methods of use that is safe to use.

Another object of the disclosure is to provide a portable person tracking fan system, process, and methods of use that is accurate.

Yet another object of the disclosure is to provide a portable person tracking fan system, process, and methods of use that is robust.

Another object of the disclosure is to provide a portable person tracking fan system, process, and methods of use that can be used with various digital platforms.

Yet another object of the disclosure is to provide a portable person tracking fan system, process, and methods of use that provides a user interface.

Another object of the disclosure is to provide a portable person tracking fan system, process, and methods of use that is quick and efficient.

Yet another object of the disclosure is to provide a portable person tracking fan system, process, and methods of use that is easy to program to various predetermined rule sets.

Another object of the disclosure is to provide a portable person tracking fan system, process, and methods of use that saves time for a user.

Yet another object of the disclosure is to provide a portable person tracking fan system, process, and methods of use that improves upon comfort for a user.

Another object of the disclosure is to provide a portable person tracking fan system, process, and methods of use that improves upon operational and or working occupational conditions in a workplace.

Yet another object of the disclosure is to provide a portable person tracking fan system, process, and methods of use that are high quality.

These and other objects, features, or advantages of the present disclosure will become apparent from the specification and claims.

### BRIEF DESCRIPTION OF THE DRAWINGS

FIG. 1 is a front, elevation view of one embodiment of a portable person tracking fan system, process, and methods of use; the view showing a fan assembly; the view showing a fan assembly having a base; the view showing the fan assembly having a support; the view showing the fan assembly having a cage; the view showing the fan assembly having a central axis; the view showing the fan assembly having a power cord connecting the fan assembly to a power supply; the view showing a fan; the view showing the fan having a plurality of vanes; the view showing the fan having a central axis.

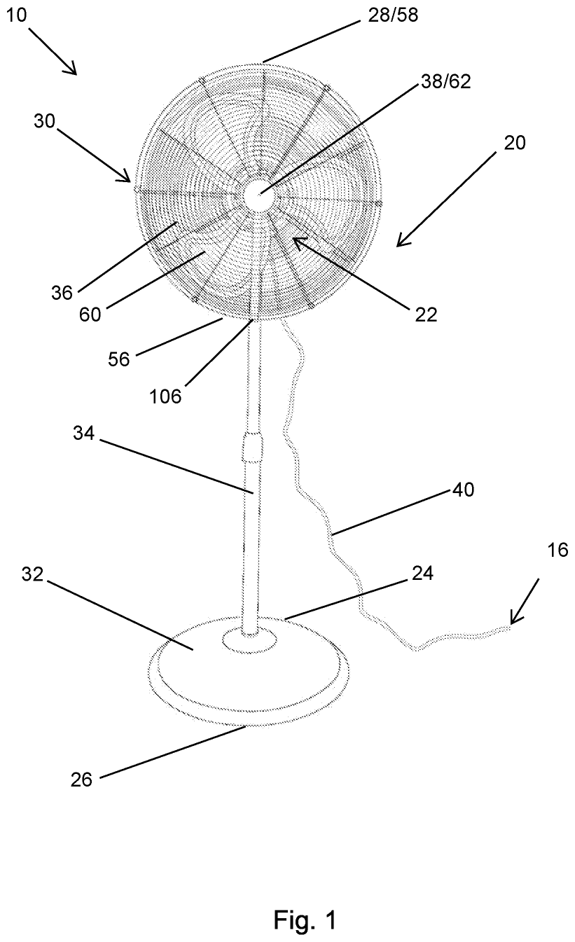

FIG. 2 is a front, elevation view one embodiment of a portable person tracking fan system, process, and methods of use; the view showing a partial fan assembly; the view showing a partial fan assembly having a support; the view showing the partial fan assembly having a cage; the view showing the partial fan assembly having a central axis; the view showing a camera; the view showing a camera wire; the view showing a tracking system.

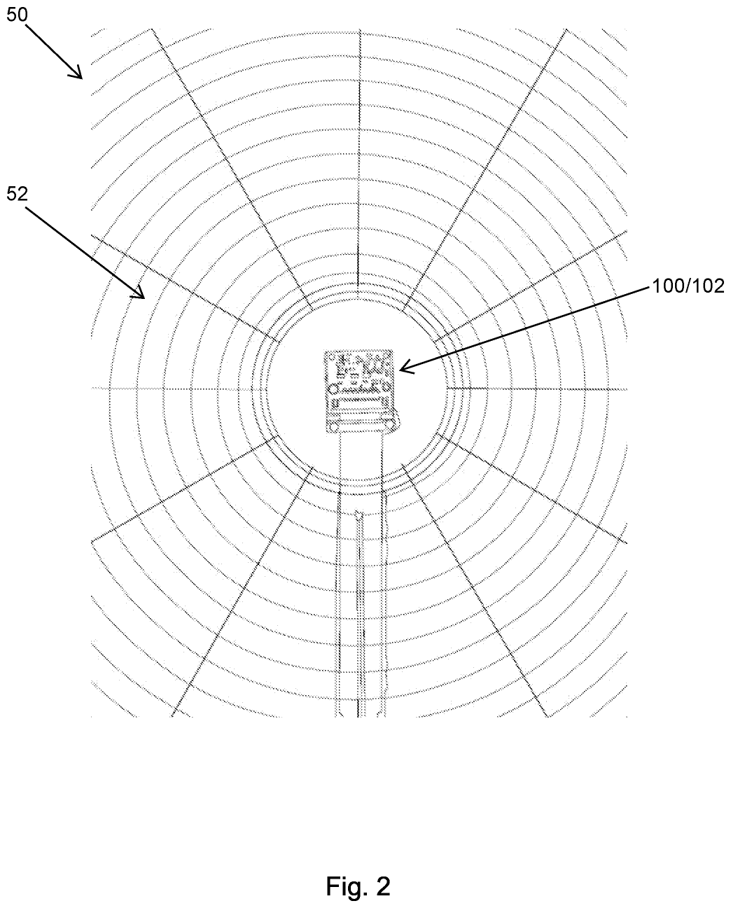

FIG. 3 is a rear, perspective view of one embodiment of a portable person tracking fan system, process, and methods of use; the view showing a partial fan assembly; the view showing a partial fan assembly having a support; the view showing the partial fan assembly having a cage; the view showing the partial fan assembly having a central axis; the view showing a fan; the view showing a fan having a plurality of vanes; the view showing a fan having a central axis; the view showing a housing; the view showing a housing having a plurality of control features; the view showing the housing having a plurality of vents; the view showing a housing having a plurality of attachment features.

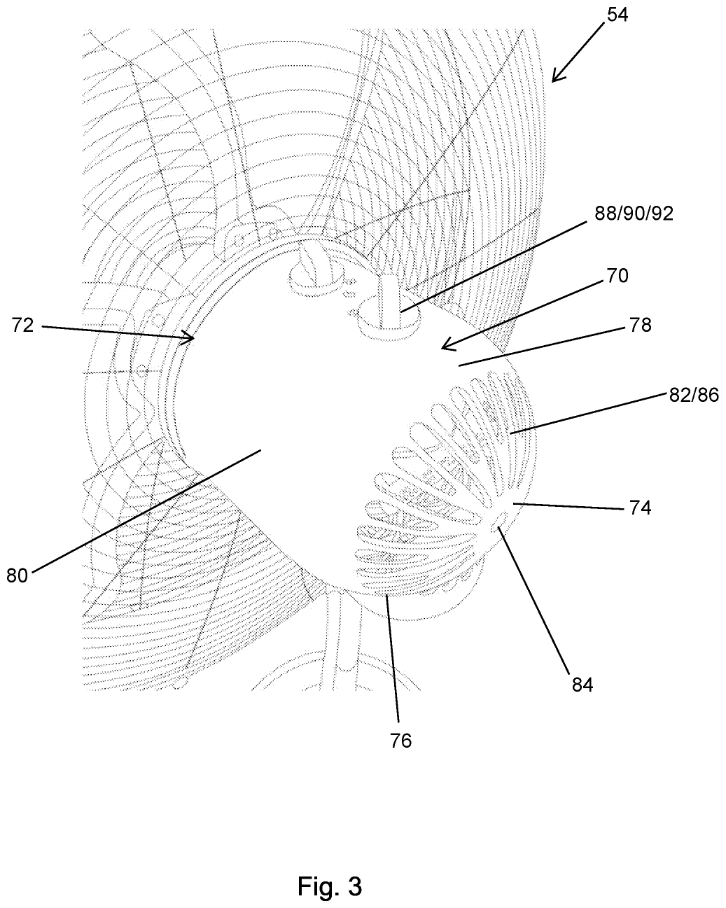

FIG. 4 is a rear, perspective view of one embodiment of a portable person tracking fan system, process, and methods of use; the view showing a tracking assembly; the view showing a motor housing; the view showing a plurality of switches and onboard computing components; the view showing novel processing features and portions of the camera and tracking system.

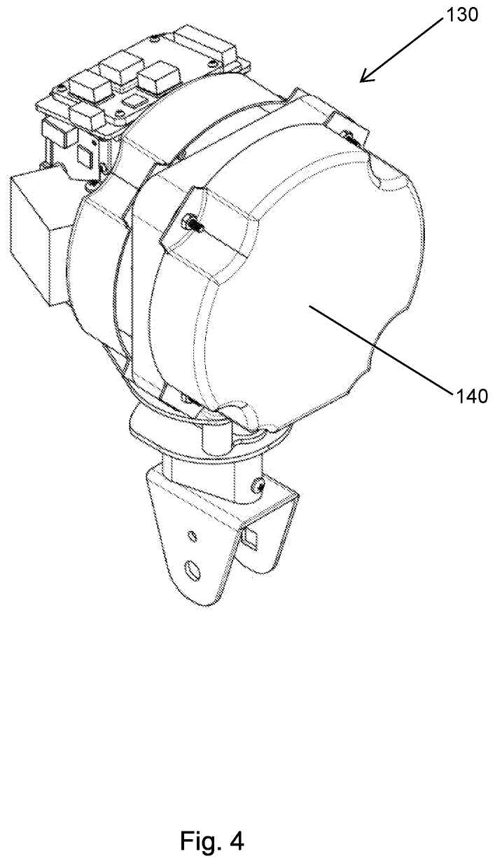

FIG. 5 is a front, perspective view of one embodiment of a portable person tracking fan system, process, and methods of use; the view showing a tracking assembly; the view showing a motor housing; the view showing a plurality of gears and other motor driver and actuator features; the view showing a plurality of switches and onboard computing components; the view showing novel processing features and portions of the camera and tracking system.

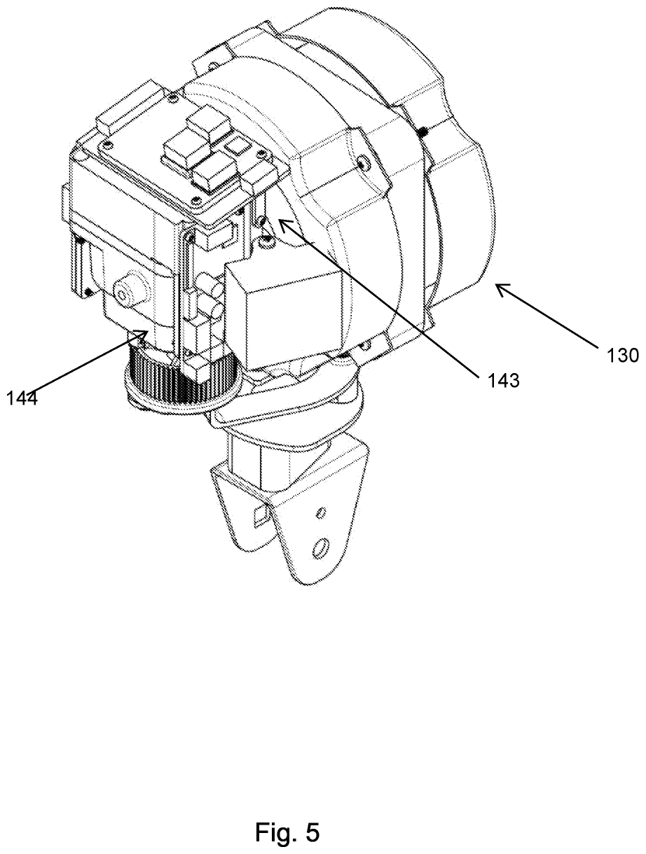

FIG. 6 is a top view of one embodiment of a portable person tracking fan system, process, and methods of use; the view showing a tracking assembly; the view showing a motor housing; the view showing a plurality of switches and onboard computing components; the view showing novel processing features and portions of the camera and tracking system.

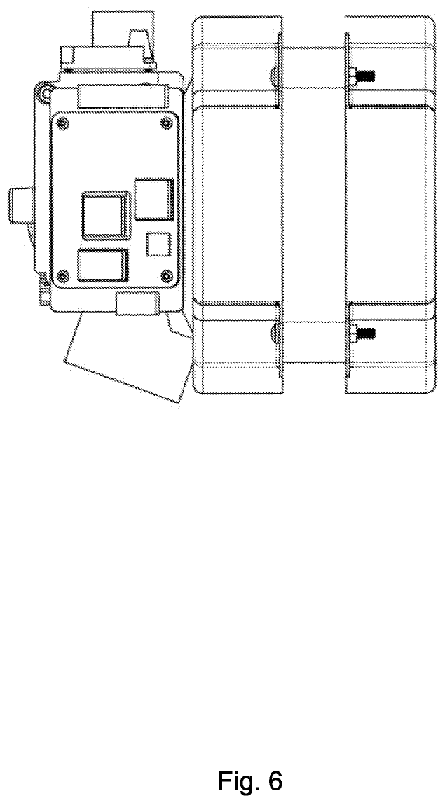

FIG. 7 is a bottom view of one embodiment of a portable person tracking fan system, process, and methods of use; the view showing a tracking assembly; the view showing a motor housing; the view showing a plurality of gears and other motor driver and actuator features; the view showing a plurality of switches and onboard computing components; the view showing novel processing features and portions of the camera and tracking system; the view showing a plurality of attachment features.

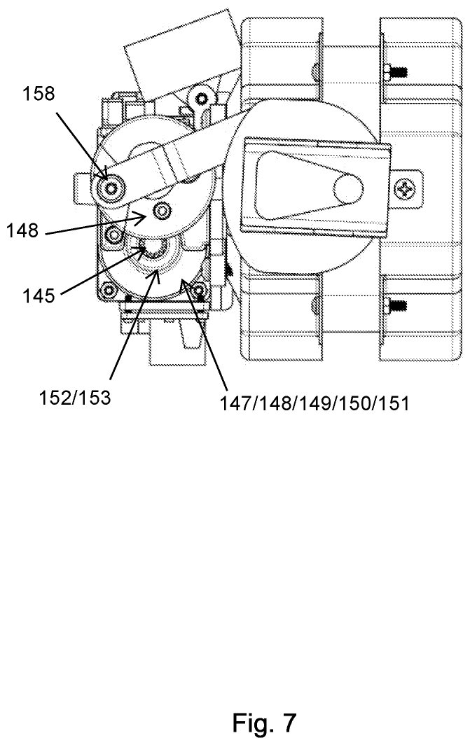

FIG. 8 is a side view of one embodiment of a portable person tracking fan system, process, and methods of use; the view showing a tracking assembly; the view showing a motor housing; the view showing a plurality of gears and other motor driver and actuator features; the view showing a plurality of switches and onboard computing components; the view showing novel processing features and portions of the camera and tracking system.

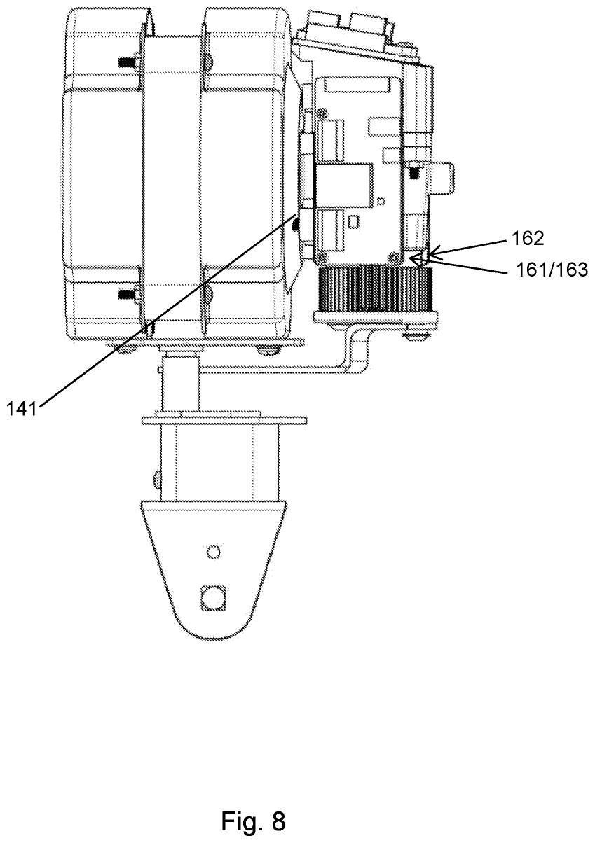

FIG. 9 is a side view of one embodiment of a portable person tracking fan system, process, and methods of use; the view showing a tracking assembly; the view showing a motor housing; the view showing a plurality of gears and other motor driver and actuator features; the view showing a plurality of switches and onboard computing components; the view showing novel processing features and portions of the camera and tracking system.

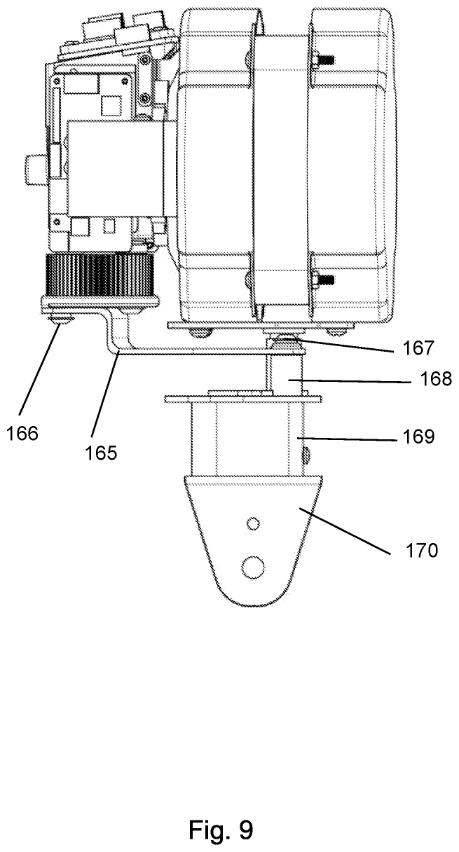

FIG. 10 is a rear, elevation view of one embodiment of a portable person tracking fan system, process, and methods of use; the view showing a tracking assembly; the view showing a motor housing; the view showing a plurality of attachment features.

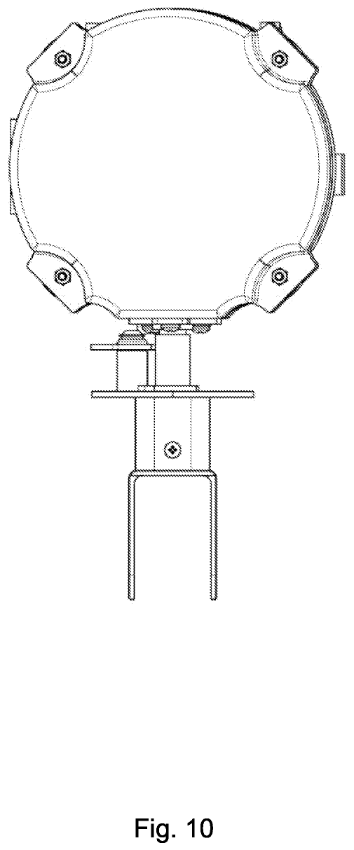

FIG. 11 is a front, elevation view of one embodiment of a portable person tracking fan system, process, and methods of use; the view showing a tracking assembly; the view showing a motor housing; the view showing a plurality of gears and other motor driver and actuator features; the view showing a plurality of switches and onboard computing components; the view showing novel processing features and portions of the camera and tracking system; the view showing a plurality of attachment features.

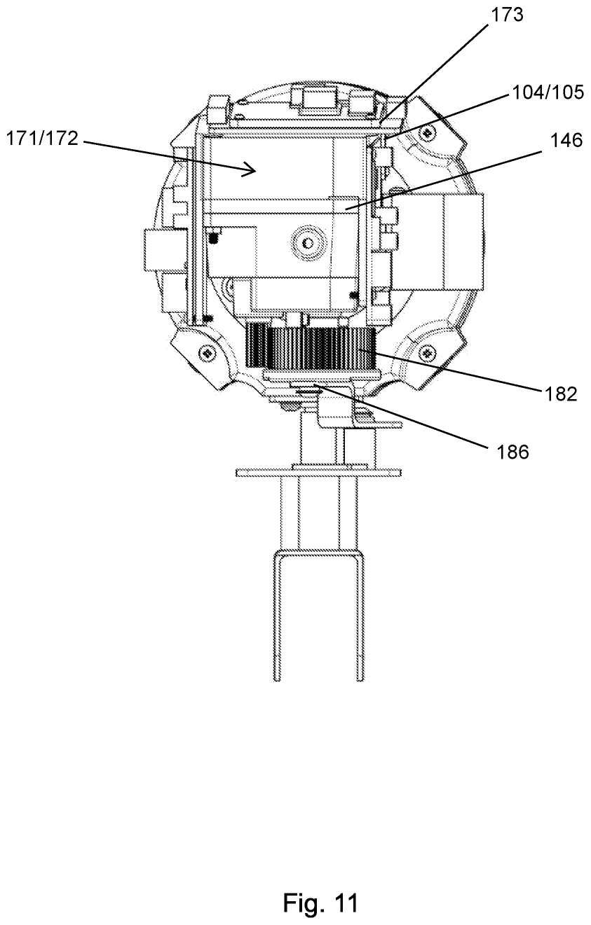

FIG. 12 is an exploded, rear, perspective view of one embodiment of a portable person tracking fan system, process, and methods of use; the view showing a tracking assembly; the view showing a motor housing; the view showing a plurality of gears and other motor driver and actuator features; the view showing a plurality of switches and onboard computing components; the view showing novel processing features and portions of the camera and tracking system; the view showing a plurality of attachment features.

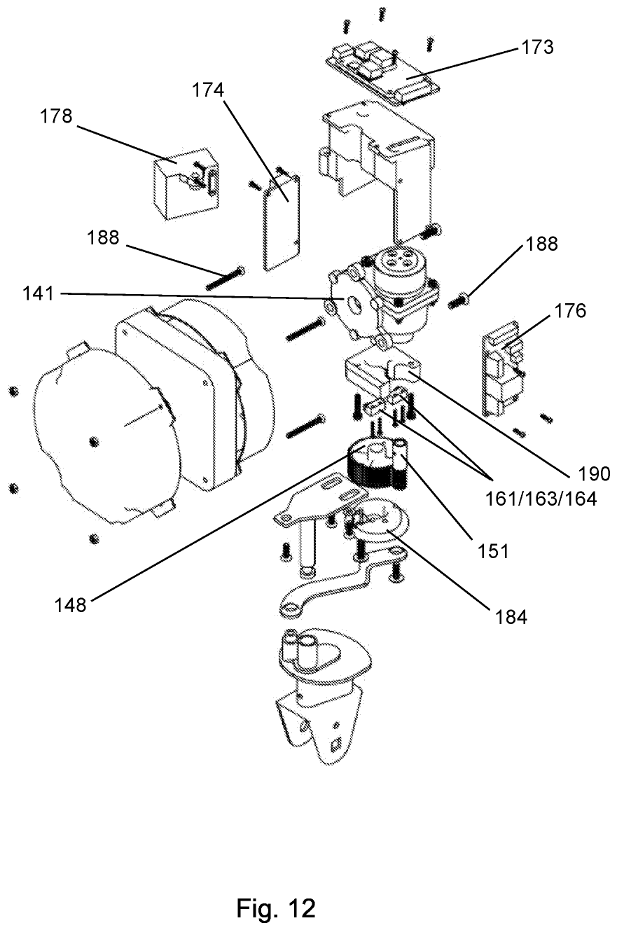

FIG. 13 is an exploded, rear, perspective view of one embodiment of a portable person tracking fan system, process, and methods of use; the view showing a tracking assembly; the view showing a motor housing; the view showing a plurality of gears and other motor driver and actuator features; the view showing a plurality of switches and onboard computing components; the view showing novel processing features and portions of the camera and tracking system; the view showing a plurality of attachment features.

FIG. 14 is an exploded, side, elevation view of one embodiment of a portable person tracking fan system, process, and methods of use; the view showing a tracking assembly; the view showing a motor housing; the view showing a plurality of gears and other motor driver and actuator features; the view showing a plurality of switches and onboard computing components; the view showing novel processing features and portions of the camera and tracking system; the view showing a plurality of attachment features.

FIG. 15 is an exploded, front, elevation view of one embodiment of a portable person tracking fan system, process, and methods of use; the view showing a tracking assembly; the view showing a motor housing; the view showing a plurality of gears and other motor driver and actuator features; the view showing a plurality of switches and onboard computing components; the view showing novel processing features and portions of the camera and tracking system; the view showing a plurality of attachment features.

FIG. 16 is a diagram illustrating a method of operation of one embodiment of a portable person tracking fan system, process, and methods of use; the view showing an architecture and interactions of a computing system and processing system in engagement with user detection and camera tracking, and subsequent tracking movements of an airflow device.

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In the arrangement shown, as one example, a portable person tracking fan system, processes, and methods of use are presented. In the arrangement shown, as one example, the present disclosure includes, but is not limited to, a camera, a camera wire and/or camera transceiver, a computer platform, a motor, a gearbox, a spindle, and a plurality of rotation arms, among other components, features and functionalities.

In the arrangement shown, as one example, a camera is configured to record environmental information and variables, record high resolution video and send this data for processing. In this way, and in the arrangement shown, the data can be communicated to various components and cause a fan to operate in a particular way. The fan may include, but is not limited to a grill, a wire cover, a motor, fan blades, and other components, features and functionality.

In the arrangement shown, as one example, the computing platform is mounted inside the fan head. In this way, the computing platform may be onboard the fan and receive a video and/or video feed from the camera. Furthermore, the computing platform includes a processor and/or plurality of microprocessors for executing code, in real time, and onboard. In this way, the system can execute a single shot objection detection machine learning model with the architecture of the computer platform system. In this way, the system can execute a predetermined set of rules and learn new rules and modify rules. Furthermore, in this way, the system can detect the location of a user and/or plurality of users through the video frames and/or captured data. In this way, the system may also include a gradient descent for processing and learning information.

In the arrangement shown, as one example, the system includes a motor driver that receives commands from the computing platform after processing. The motor driver and/or plurality of motor drivers then cause the fan to move and/or rotate according to the predetermined set of rules and/or learned rules. Furthermore, the data, after processing and instructions, may cause the gearbox and/or motor to increase torque, which may be connected to the spindle and/or planetary gearbox. In this way, varying fan speeds can be caused. In this way, the spindle may rotate inside a spindle housing that has a limb and/or limb of the spindle. Furthermore, the arrangement shown, also includes a connection point and head pivot point which provides for rotation and/or movement of the fan with minimal friction. Furthermore limit switches are incorporated which can limit the range of motion, as desired.

Some of this data capture includes, but is not limited to, high resolution video, image capture, video frame capture, capturing images, object recognition within images, counting of objects within images, combined with location, spatial geometries, historical data including location of regular anomalies, temperature of objects, distance of objects, size of objects, and other information can be used to create customized information, identify patterns, and more.

System:

With reference to the figures, a portable person tracking fan system, process, and methods of use 10 (hereafter referred to as “person tracking fan system”, “airflow tracking system”, “automated tracking coolant system”, “autonomous airflow system”, or simply “system”) is presented. Person tracking fan system 10 is formed of any suitable size, shape and design.

In the arrangement shown, as one example, airflow tracking system 10 is formed of any suitable size, shape, and design and is configured to provide an effective and efficient user tracking system which autonomously causes airflow to be directed in a particular direction and autonomously adjusts the direction of airflow from a fan system as desired.

In the arrangement shown, as one example, automated tracking coolant system may comprise remote servers, databases, application servers, application databases, product databases, mobile applications, and/or computers; all of which in continuity or as separate acts fulfill the functions disclosed herein. Autonomous airflow system 10 also includes, in the embodiment(s) depicted, a graphical user interface, a user, or plurality of users, a power supply 16, a smart device, a control system, a fan assembly 20, a fan 50, a fan housing 70, a camera system 100, a sensor system, a fan motor 130, an onboard computing system 173, a remote computing system, a communication and/or control system, an application server, and a mobile computing application, among other components, features, and functions.

Graphical User Interface:

In the arrangement shown, as one example, system 10 may include a graphical user interface. Graphical user interface is formed of any suitable size shape and design and is configured to allow a user to view interact with, manipulate, and visually access environmental and system data and information, information related thereto, and/or view various data for various parameters associated with the fan system and/or environments and/or add information to a the system and/or add information about a parameter related to a user and/or tracking item and/or object data and/or change the settings of the sensors and/or change the settings of the tracking system operation.

Graphical user interface is an exemplary method by which systems of the present disclosure may cause a fan to track a user and/or make programming changes to the operation of system 10. Employing graphical user interface, enhances a user's interactions with system 10 in the form of awareness and knowledge of data within the system 10. System 10 provides direct links to a user's history, settings, programming, and other information related to a particular user being tracked or group of users being tracked and/or a particular fan and/or a plurality of fans and/or a particular environment. In this way, graphical user interface provides a means for a user to make adjustments to the operation and functionality of system 10. Additionally, graphical user interface provides direct interaction with the autonomous tracking system, geometrical measurements, objects, system speed, trajectory and/or airflow, and more. Additionally, local geographic information with relation to the system can be added, viewed, or retrieved.

Display of Graphical User Interface: In the arrangement shown, as one example, system 10 includes a graphical user interface. Graphical user interface may include a display, which is configured to show and display information, including data, for review and interpretation by a user or plurality of users, or a plurality of users interacting with one another.

In the arrangement shown, as one example, an interactive user display is formed of a display screen, such as that of a desktop computer, laptop computer, monitor, tablet, smart phone, smart TV, projector, virtual reality display or any other device or form of a display. In the arrangement shown, as one example, interactive user display comprises a series of interactive user display pages, however, the interactive user display may consist of a single page or any other method of displaying information on a display as could be adapted to various size screens, devices, or user preferences. The interactive user display can display various user and/or system information which is retrieved and/or requested.

User (or Plurality Thereof):

In the arrangement shown, as one example, system 10 includes a user. User may be any user interacting with or utilizing the system 10. This may include viewing, controlling, analyzing, manipulating, and/or interacting with system 10. User is not limited to a single user but may be a plurality of users. Said another way, system may be assigned to track a single user and/or may be utilized to track a plurality of users in various ways.

Power Supply:

In the arrangement shown, system 10 includes a power supply 16. Power supply 16 is formed of any suitable size, shape and design and is configured to provide power to the various components of the person tracking fan system 10. Power supply 16 in the arrangement shown, does not move such that other mechanical components of the system may “move”. Instead, the power supply 16 is configured as a source of energy for the autonomous tracking system 10.

In the arrangement shown, as one example, power supply 16 is formed of a power cord 40. In this way, the power cord 40 is plugged into an outlet and/or hard-wired and is directly connected to system 10, transferring electrical power to the system. In another arrangement, power supply 16 is formed of a plurality of batteries or a plurality of rechargeable batteries.

The rechargeable battery, or storage battery, is an electrical battery designed to be charged, discharged, and recharged as many times as needed, as opposed to a disposable or primary battery, which is disposed of after use. However, a primary battery or disposable battery is also hereby contemplated for use. The rechargeable battery, in the arrangement shown, is formed of one or more electrochemical cells. In the arrangement shown, as one example, power supply is formed of a rechargeable battery. However, the power supply may also consist of a plurality of rechargeable batteries and/or a plurality of batteries.

In the arrangement shown, as one example, the power supply may also be formed of other power types and/or generators including, but not limited to solar power supply, or other elements into mechanical energy, as well as other power supply types.

Furthermore, in the arrangement shown, power supply may also include all necessary components, whether wires, conductors, cases, holders, and the like which provide for necessary connections and stabilization for power supply components.

Smart Device:

In the arrangement shown, as one example, system 10 may include a smart device (also referred to as an “onboard control system”, a “mobile phone”, a “smartphone”, or simply a “device”). Smartphone is formed of any suitable size, shape, and design and is configured to serve as an interface between the attractor and the user.

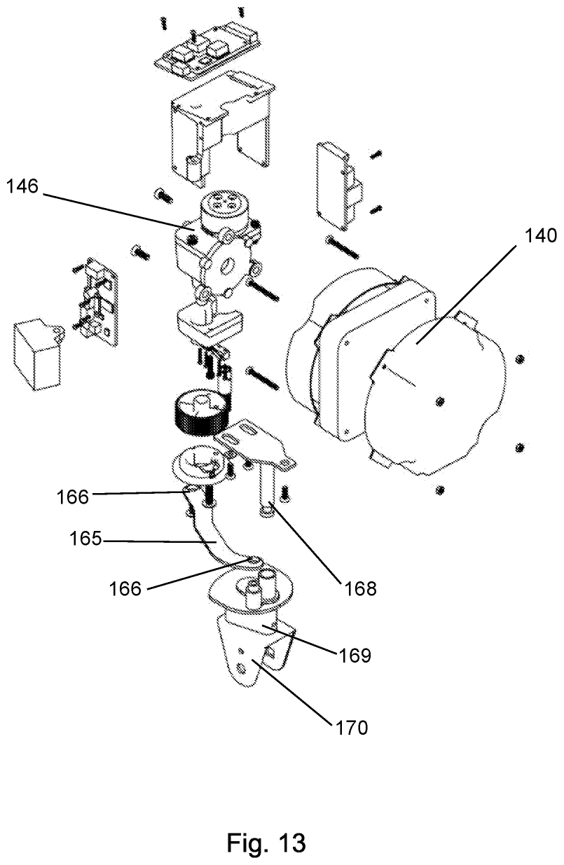

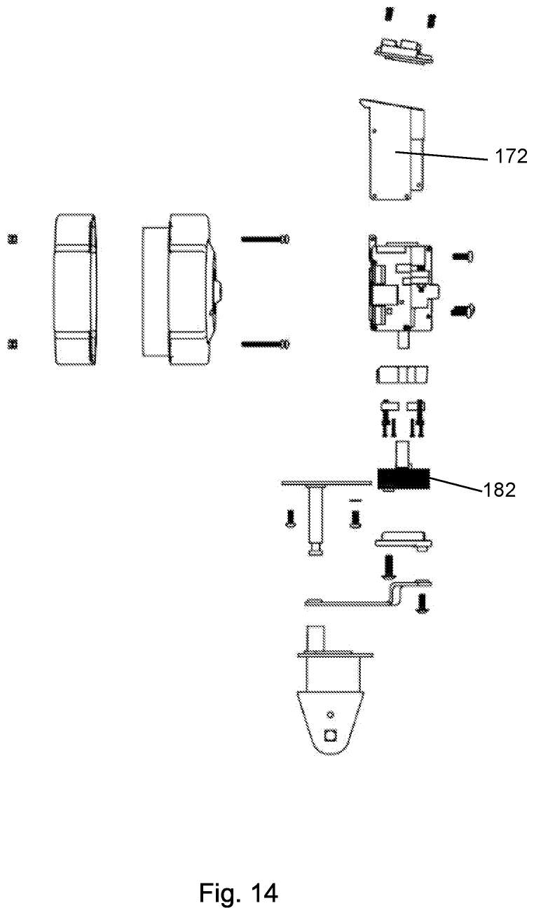

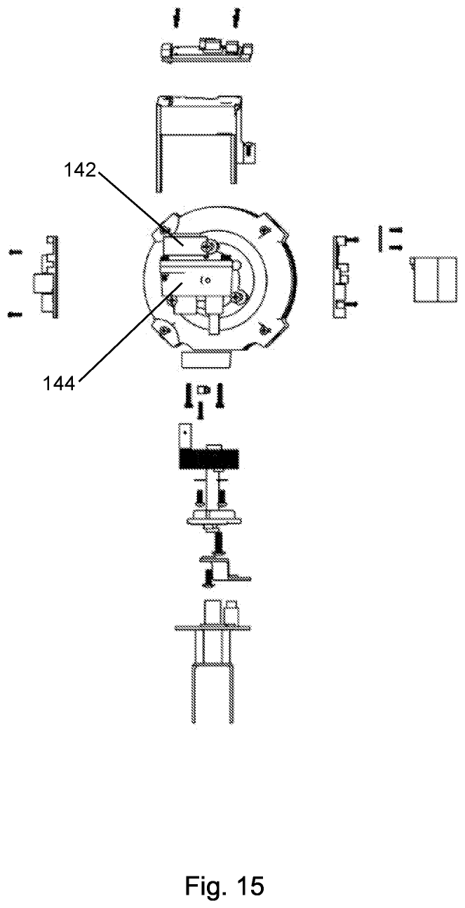

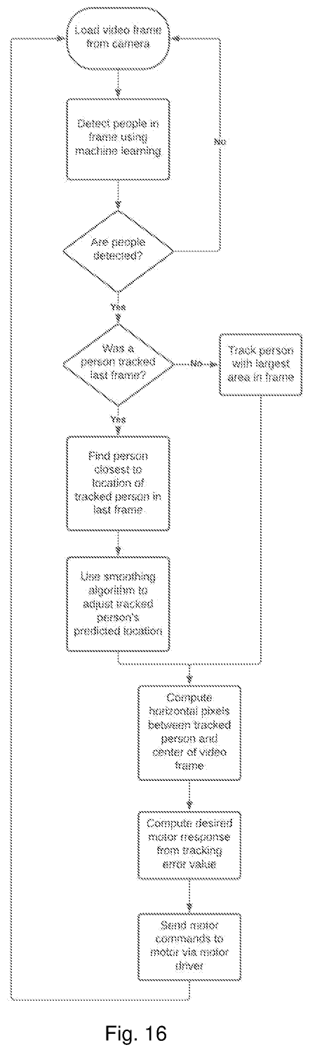

In this way, and as is shown in one embodiment (with specific reference to FIGS. 13 to 24), smart device is included and configured to serve as a display screen and interaction feature. This may include, but is not limited to, programming graphical user interface, previewing images and/or data to be captured, modifying data which has been captured, viewing data which has been captured, entering data, manipulating the devices via zoom and other functionality, changing the tracking settings of the systems, modifying other settings of the hardware components of the camera and/or fan, such as airflow metrics (to be further described herein), and the like.

Control System:

Controller: In the arrangement shown, as one example, system 10 includes a control system (also known as a “controller”, or “control device”). Controller is formed of any suitable size, shape, and design and is configured and programmed to cause system 10 to operate when any one of the plurality of controls (or “plurality of buttons”, or “plurality of dials”) are engaged. In this way, the controller, in some embodiments as presented, is programmed such that the button or dial is pressed or utilized to cause components of system 10 to operate, then the controller will activate the motor in a way which causes an airflow, and for the fan assembly to track a user or plurality of users.

Plurality of Buttons: In the arrangement shown, as one example, system 10 includes a plurality of buttons (or “plurality of controls”, or “plurality of dials”) 88/90/92. Plurality of buttons 88/90/92 are formed of any suitable size, shape, design, and vary from airflow device design, as may be applicable to various environments, and are formed to provide a user a means of interacting with and controlling the airflow and tracking system. More specifically, and without limitation, the buttons and/or controls may also be part of a smart device and/or graphical user interface.

In the arrangement shown, as one example, the plurality of buttons 88/90/92 includes speed control functions, direction and/or tracking activation, and more. In addition to being located on the exterior of the housing and/or on the fan housing (to be further discussed herein), the controls may also be located on a wall, or smart device and may vary according to various applications, functionality, controls, and features.

While a traditional control for a dial is hereby contemplated for use. Other controls and/or buttons are also contemplated for use. This includes, but is not limited to, analog control systems, digital control systems and functionality, touchscreen controls, switch controls, actuators, and other smart devices through wireless and/or bluetooth communication, as well as, systems that have been retrofit, and the like or any combination thereof.

Fan Assembly:

In the arrangement shown, as one example, system 10 includes a fan assembly 20. Fan assembly 20 is formed of any suitable size, shape, and design and is configured to provide an airflow. Additionally, fan assembly 20 is configured to provide mechanical tracking, safety mechanisms, and other components that aid in the functionality of system 10 and other components disclosed herein.

In the arrangement shown, as one example, fan assembly 20 includes, but is not limited to, an assembly which extends a length from a front end 22 to a second end 24, having a bottom 26 and a top 28 which form an assembly between opposing sides 30. Furthermore, the fan assembly, shown in the example, has a base 32 which provides stabilization and other features. Furthermore, the fan assembly 20 includes a support 34 extending from the base 32 to the fan (to be further described herein. Furthermore, the fan assembly 20 includes a fan cage 36. The fan cage 36 providing safety, and other benefits for the protection of others, and mechanical equipment, and the steadying of airflow, and the like. Furthermore, the fan assembly 20 also includes a central axis 38 for which the fan assembly and/or fan rotates about. Furthermore, the fan assembly 20, in the example shown, includes a power cord 40 for providing a connection to a power source for the fan assembly 20. These and other components, features, and functionality are included in example and are hereby contemplated.

In the arrangement shown, as one example and for simplicity of explanation purposes, a single fan assembly is shown. However, any number of fan assemblies is hereby contemplated for use. Other fan assembly set ups might include two fan assemblies, three fan assemblies, four fan assemblies, or more. Furthermore, a single fan assembly may direct airflow from one direction to another. However, fan assemblies may be oriented in different directions such as on opposite sides of an environment, above and/or below an environment, and the like so as to cause a plurality of airflows.

In the arrangement shown, a fan assembly can be a standalone unit. However, a fan assembly may also be the integration and/or use of an existing system which causes an airflow. For example, an existing duct and/or vent system may be utilized in a retrofit system or the like so that a mini split fan, a ceiling fan, or the like can be adapted for tracking and causing an airflow, and the like.

Fan:

In the arrangement shown, as one example, system 10, includes a fan 50. Fan 50 (also known as “airflow device”, or “blower”) is formed of any suitable size, shape, and design and is configured to provide an airflow for system 10. Said another way, fan 50 is configured to cause air movement in a desired direction at a desired time. In the arrangement shown, as one example, a common fan with a plurality of blades and a central axis is shown for simplicity, and in order to provide an appearance of a fan to indicate the cause of an airflow.

In the arrangement shown, as one example, the airflow device 50 extends a length from a first end 52 to a second end 54—the first end being the front of the fan 50 and/or the direction of typical airflow and/or airstream. The second end 54 being the rear of the fan 50 or negative air space. Furthermore, and in the arrangement shown, fan 50 has a bottom 56 and a top 58 between opposing sides. In the arrangement shown, as one example, the fan 50 further includes, in one arrangement, a plurality of vanes 60 or a plurality of blades. Furthermore, and in the arrangement shown, as one example, the fan is centered around a central axis 62. This is true in the arrangement of a common fan where the vanes are caused to spin around a center point, causing air displacement.

Said another way, and in the arrangement shown as one example, system 10 may include a fan 50. Said another way, fan 50 or plurality of fans 50 are formed of any suitable size, shape and design and are configured to cause air to move through the system 10. Fan 50 may be formed of any suitable size, shape, and design and may be configured to operate at variable speeds as controlled by the variable speed control system and other information provided in the present disclosure.

Additionally, and in the arrangement shown, as one example, fan and/or motor 50 may be configured with a brushless direct current motor, an alternating current motor, or other powered motor. This novel aspect of the invention provides the state of the art, for the first time, with application of this type of motor through various research and development. The application of this type of motor was impossible in this art prior to this disclosure. The application of this motor provides the state of the art with improved control functionality as well as improved efficiency and improvements upon various types of operational settings.

Fan Housing:

In the arrangement shown, as one example, system 10 includes a housing 70 (hereafter referred to as “Main Body”, “Main Housing”, “Containment Module”, “Housing System”, or simply “Body”). Housing 70 is formed of any suitable size, shape and design and is configured to hold and support the various components of system 10. Furthermore, housing 70 is also configured to provide support and allow for system 10 to be integrated seamlessly and or efficiently into various locations and/or adapted to various system types, such as easy implementation and connection with retrofit systems.

In the arrangement shown, as one example, housing 70 is generally rectangular and box-like in overall shape, while having a number of curved and/or smooth edges and/or surfaces. However, other shapes are hereby contemplated for use such as cylindrical or tunnel like and more. In the arrangement shown, as one example, the housing 70 extends in a rectangular shape for a length from a first end 72 to a second end 74. Furthermore, in the arrangement shown, the housing has a bottom 76 and a top 78—which also extend the length of the housing 70 so as to create a uniform surface of the housing and/or an exterior surface and an interior surface caused by thin panel-like walls. The fan also includes opposing sides 80.

Furthermore, and in the arrangement shown as one example, housing 70 also includes a plurality of vents 82 to allow for air circulation. Furthermore, in the arrangement shown, as one example, the housing 70 includes a plurality of attachment features for enclosing the housing 70, as well as, securing the housing to other components and/or surfaces. Furthermore, the housing 70 may include a plurality of apertures for fasteners to slide through, and the like. Furthermore, the housing 70, in the arrangement shown, is configured to hold a plurality of manual control features 88, speed control features 90, and movement control features 92, so that a user can access these various features.

Furthermore, and in the arrangement shown as one example, at least one of the opposing sides contains an access panel (also referred to as a “side door”). Access panel is formed of any suitable size, shape, and design and provides access to the hollow interior of the housing 70 from the exterior of the housing 70. In this way, the interior can be accessed for maintenance and/or modifications and the like. The access panel may also contain attachment features for securing and/or opening and/or closing the access panel. Furthermore, this may include relatively air tight seals and the like so that pressure and the like are maintained with the system 10.

Furthermore, and in the arrangement shown, as one example, the housing 70 may include attachment features and attachment apertures. Plurality of attachment features are formed of any suitable size, shape, and design and are configured to secure the housing 70 to a desired location. In the arrangement shown, as one example, the attachment features of the housing 70 are on the top of the housing and are configured such that the housing can be suspended from supports above the housing 70. In another arrangement the attachment features may be configured elsewhere so the housing 70 can be mounted on top of structural supports or along the side of supports, secured to the fan, and the like.

Furthermore, and in the arrangement shown, as one example, the housing 70 may also include a display. Display (also known as “display screen”, or “screen”, or “display panel”) is formed of any suitable size, shape, and design and is configured to display and/or convey information to a viewer about system 10. Display panel, in the arrangement shown, may be configured as a touchscreen so that users can also interact with and/or make changes to the operations of system 10. Display panel, in an alternative embodiment can be viewed remotely via a computer smartphone, tablet, or other device and the like. Similarly, housing 70 may also include various gauges and control features.

Airflow:

In the arrangement shown, as one example, system 10 includes an air flow (also referred to as “airstream” or “plurality of airstreams”). A plurality of airstreams may be caused to move through the interior of the cage of the fan and thus be treated by system 10. In the arrangement shown, as one example, a single airstream is discussed for simplicity purposes.

Airstream and or plurality of airstreams may include a direction of flow, an air speed and/or velocity, a turnover rate, clean air and/or air filtration and measurements associated with air contaminants, contaminated air, contaminants, mold measurements and other sensory measurements of the air, odor, pressure, and more.

Camera System:

In the arrangement shown, as one example, system 10 includes an image capture system 100 (or “data capture system”, or “data system”, or “video system”, or “video capture system”). Image capture system 100 is formed of any suitable size, shape and design and is configured to capture live environmental data of the environment the tracking and airflow system is in. In the arrangement shown, as one example, image capture system includes a camera platform and/or camera 100, a camera wire and/or communication system 102, a camera clamp 105, and a camera wire cover 106.

Furthermore, in the arrangement shown, as one example, camera system 100 may also include a computer, a plurality of sensors, and an application server for processing data. Additionally, the image capture and processing system may also include various communication components and features, among other components and features.

Camera Platform (Image Capture Platform):

As part of the system and as part of the image capture system 100, and in the arrangement shown, as one example, system 10 may include a camera platform and/or camera mounting feature (or “image capture platform” or “image platform”). Image platform is formed of any suitable size, shape, and design and is configured to provide support for the image capture system which forms a portion of system 10.

Data Processing System:

In the arrangement shown, as one example, system 10 includes a computer. Computer is formed of any suitable size, shape, and design and are configured to provide for the main off-board computing processing and implementation of computer handling of data from data gathering performed within the environment. The data processing may include, but is not limited to, artificial intelligence of sorting and organizing images gathered which may include stitching and object recognition. In the arrangement shown, as one example, computer may include both an onboard computer device and an off-board computer, a processor, a memory, a microcontroller, a printed circuit board, a mobile computing device, a microprocessor, a receiver/transceiver, and an antenna, among other computing components and/or features.

Sensor System:

In the arrangement shown, as one example, system 10 includes a sensor system. Sensor system is formed of any suitable size, shape, and design and may include one or more sensors and/or one or more sensing technologies. In the arrangement shown, as one example, the sensor system is configured to detect and communicate information related to system 10 as well as the surroundings and/or environment of system 10 and/or tracking of a user in the environment.

Other Sensors:

In addition to the distance and image sensors discussed herein, system 10 may also include other sensors, such as temperature sensors, moisture sensors, heat sensors, light sensors, motion sensors, and other sensors. In the arrangement shown, as one example, system 10 includes at least one other sensor. Other sensors are formed of any suitable size, shape and design and are configured to facilitate sensing of the airflow and/or environment and converting the characteristics of the outside space and/or environment into computer readable information. Other sensors are used to detect and respond to some type of input from the physical environment.

Other sensors may be used for sensing a single component of a user and/or environment, or alternatively another sensor may be used to sense a plurality of components of a user (such as distance or size or body temperature) and/or environment. For example, the specific input of other sensors may be light, heat, motion, moisture, pressure, or any one of a great number of other environmental parameters. Another sensor is a device, module, or subsystem whose purpose is to detect events or changes in its environment and send the information to other electronics, frequently a computer processor. The output of another sensor is generally a signal that is generally converted to human-readable display at the sensor location or transmitted electronically over a network for reading or further processing. Both analog sensors and/or digital sensors are hereby contemplated for use. In one arrangement, another sensor and/or microsensor sends information to a processor for use with other electronics.

Tracking Assembly:

In the arrangement shown, as one example, system 10 includes a tracking assembly 130. Tracking assembly 130 is formed of any suitable size, shape, and design and is configured to provide mechanical tracking of airflow in order to direct airflow in a desired direction and manipulate the fan and/or mechanical equipment as instructed to by the computer platform (to be further described herein).

In the arrangement shown, as one example, tracking assembly 130 may include a motor housing 140, a base mount 141, a motor 142, a driver 143, a gearbox 144, a gearbox shaft 145, a gearbox connector plate 146, gears 147, output gear 148, sun gear 149, planet gear 150, pinion gear 151, motor gear connector 152, motor gear shaft 153, a spindle 158, a top of spindle, a bottom of spindle, a limit switch 161, limit switch bumpers 162, inside limit switch 163, outside limit switch 164, rotation arms 165, rotation pivot 166, fan head pivot 167, fan head pin 168, fan head connector 169, fan head bracket 170, onboard computing system 171, processor mount 172, a computer module (also referred to as a motor driver) 173, a motor driver 174, a fan interface 176, a fan capacitor 178, an output gear 182, a rotation output connector 184, a vibration damper 186, a plurality of attachment features 188, and a limit switch mount 190, among other components, features, and functionality.

Computing Platform:

In the arrangement shown, as one example, system 10 includes a computing platform (or “computer”, or “computer platform”). Computing platform is formed of any suitable size, shape, and design and is configured to provide computing support, power, and computing processing for both onboard computing functionality as well as communication for off-board or server computing functionality. In this way, an onboard computing system, among other components and features on top of the platform.

In the arrangement shown, as one example, system 10 includes a computer. Computer is formed of any suitable size, shape, and design and is configured to provide for the main off-board computing processing and implementation of computer handling of data from data gathering performed within the environment. The data processing may include, but is not limited to, artificial intelligence of sorting and organizing images and/or videos and/or video frames gathered which may include stitching and object recognition and/or layer and layer recognition of continuous scans of a fan and/or area and/or structure and/or operations of system 10 and/or video scans.

Onboard Computing System:

In one arrangement, as is shown, system 10 includes an onboard computing system (or “onboard computing device”, or “onboarding computing system”, or “onboard computer device”). Onboarding computing system is formed of any suitable size, shape, and design and configured to handle onboard computing operations, as are necessary for the operation of the system 10. Onboarding computing device is connected with electronic network and/or database and/or server or cloud via communication means, bluetooth communication, bluetooth low energy chip (BLE onboard), and may include a processor, a memory, a microcontroller, a printed circuit board, a microprocessor, a receiver/transceiver, may include at least one antenna, and a global positioning system, among other components.

Computing device may be formed of and/or include any computing device capable of displaying and manipulating data in the manners described herein. Computing device may include for example a desktop computer, a laptop computer, a tablet, smart phone, or any other computing device or other interactive device.

Computing device may be a single consolidated component, or alternatively, computing device may be formed of a plurality of interconnected components that may be co-located or located at different geographic locations. Computing device may be cloud based or it may be hardware based, or cloud capable. In addition, the connected components of computing device, including processor, memory, software and interactive user display, may be co-located with computing device or located at different geographic locations, and the like. That is, computing device may be made of any form of a device or system that individually or collectively performs the computing operations of system 10.

Printed Circuit Board:

In the arrangement shown, as one example, system 10 includes a plurality of custom designed printed circuit boards (“PCB”). PCB is formed of any suitable size, shape and design and is configured to facilitate carrying and/or holding other components and/or parts necessary to carry out various computation and/or related functions of system 10. PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

In an alternative embodiment, system 10 may not include an onboard computer device, but instead houses only a receiver and/or transceiver for sending and/or receiving information which is both sensed and/or information which is sensed and/or captured by the image capturing devices of system 10. In this way, system 10 may be connected to a mobile computing device via a cellular connection, a direct connection, or other connections which provide a means of receiving and/or sending communications.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”). Receiver/transceiver is connected with an antenna, such as a monopole antenna, a loop antenna, a fractal antenna, or any other form of an antenna. Antenna receives wireless signals from any other device, transmits these signals to receiver/transceiver which processes these signals and then transmits these processed signals to microprocessor which processes these signals according to instructions stored in memory. In one arrangement, system 10 re-transmits operating commands signals through receiver/transceiver so as to similarly control over-the-air communication. Communication is any form of wireless signals, or wired signals, through the air, such as a conventional remote signal, a cell phone, a wireless device, an internet connected device, a hard-wired device, or any other device capable of transmitting remote control signals.

Memory: In the arrangement shown, as one example, system 10 includes a memory. Memory may be formed of any suitable size, shape and design and is configured to facilitate selective storage and retrieval of data (including data) in association with computing devices, processors, software and interactive user display. Memory may be a single component, such as a single chip or drive or other memory device, or alternatively memory may be formed of a plurality of memory or storage components that are connected to one another that may be co-located or located at different geographic locations.

Remote Computing System:

In one arrangement, as is shown, system 10 includes a remote computing system (or “remote computing device”). Remote computing device is formed of any suitable size, shape, and design and configured to handle onboard computing operations, as are necessary for the operations of system 10. Remote computing device is connected with electronic network and/or database and/or server or cloud via communication means and includes a processor, a memory, a microcontroller, a printed circuit board, a microprocessor, a receiver/transceiver, may include at least one antenna, a power supply, and a communications system, among other components.

Computing devices may be formed of any computing device capable of displaying and manipulating data in the manners described herein. Computing devices may include for example a desktop computer, a laptop computer, a tablet, smart phone, or any other computing device or other interactive device.

Computing devices may be a single consolidated component, or alternatively, computing devices may be formed of a plurality of interconnected components that may be co-located or located at different geographic locations. Computing devices may be cloud based or it may be hardware based, or cloud capable. In addition, the connected components of computing devices, including processor, memory, software and interactive user display, may be co-located with computing devices or located at different geographic locations. That is, computing devices may be made of any form of a device or system that individually or collectively performs the computing operations of system 10.

Printed Circuit Board: In the arrangement shown, as one example, system 10 includes a printed circuit board (“PCB”). PCB is formed of any suitable size, shape and design and is configured to facilitate carrying and/or holding other components and/or parts necessary to carry out various computation and/or related functions of system 10. PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

In an alternative embodiment, system 10 may not include an onboard computer device 180, but instead houses only a receiver and/or transceiver for sending and/or receiving information which is both sensed and/or information which is sensed and/or captured by the image capturing devices of system 10. In this way, system 10 may be connected to a mobile computing device via a cellular connection, a direct connection, or other connections which provide a means of receiving and/or sending communications.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”). Receiver/transceiver is connected with an antenna, such as a monopole antenna, a loop antenna, a fractal antenna, or any other form of an antenna. Antenna receives wireless signals from any other device, transmits these signals to receiver/transceiver which processes these signals and then transmits these processed signals to microprocessor which processes these signals according to instructions stored in memory. In one arrangement, system 10 re-transmits operating commands signals through receiver/transceiver so as to similarly control over-the-air communication. Communication is any form of wireless signals, or wired signals, through the air, such as a conventional remote signal, a cell phone, a wireless device, an internet connected device, a hard-wired device, or any other device capable of transmitting remote control signals.

Memory: In the arrangement shown, as one example, system 10 includes a memory. Memory may be formed of any suitable size, shape and design and is configured to facilitate selective storage and retrieval of data (including data) in association with computing devices, processors, software and interactive user display. Memory may be a single component, such as a single chip or drive or other memory device, or alternatively memory may be formed of a plurality of memory or storage components that are connected to one another that may be co-located or located at different geographic locations.

Application Server:

In the arrangement shown, as one example, system 10 comprises remote servers, databases, and/or computers that fulfill the functions disclosed and described herein. In the embodiment depicted, system 10 comprises an application server. Application server comprises one or more computer systems adapted to transmit and receive data regarding selected datasets related to various users and/or datasets related to multiple users. Application server is adapted to query databases with unique identification codes to retrieve image information and associated environment information related to various users in system 10 has moved over and/or through and gathered data in, and/or has monitored and/or is monitoring.

Application server may transmit environmental data and/or environment related documents with respect to a single environment and/or multiple environments. Application server is also adapted to query a database. This query includes receiving and sending user tracking identification and environmental data. Additionally, application server may communicate with a cloud computing system or a mobile application, which can also be adapted to present the data in a form conducive to being viewed on a mobile device and/or handheld device.

As one of ordinary skill in the art may understand, application server, database, and other databases mentioned herein may be implemented in one or more servers. Furthermore, each may be on multiple servers to increase system efficiency, especially when handling large data gathering, following extended guidelines, extended ranges, ranges discussed herein. Additionally, multiple servers may have mirrored data to prevent data loss in case of disk failure and/or to decrease access and response times for database queries. In alternative embodiments, application server, and other database procedures may be carried out on computer-readable instructions and data stored on the customer's mobile computing device.

### Alternative Embodiments

In the arrangement shown, as one example, system 10 includes a center mounted camera, computer processing, and fan with airflow direction. Various alternative embodiments are also hereby contemplated for use.

In one example of an alternative embodiment, fan speed and movement mode controls do not utilize dials but instead can be controlled via a touchscreen and/or smart screen. Furthermore, controls may be completed via a smartphone, application on a smartphone and the like. In this way, the controls may be controlled remotely through bluetooth, wifi, and the like. Furthermore, gesture controls, voice controls, and the like are also hereby contemplated for use.

In another alternative embodiment, the camera may not be center mounted, but instead may be located in various locations. Various locations include, but are not limited to, below fan blades, above fan blades, on the sides or near perimeter locations of the fan blades or in other locations, including but not limited to remotely located from the fan and/or fans.

In another embodiment, and as will be appreciated by those skilled in the art, the predetermined set of rules, learned rules, and processing components may use a variety of code and the like to process and execute the operations herein. In this way, the single shot object detection network, various architecture, region-based convolutional networks, image segmentation networks, histogram of oriented gradients, you only look once, and other architectures can be integrated in combination and/or utilized in lieu of some of the processing systems disclosed herein for detection of location of a user in video frames, and the like. Furthermore, the post processing system used to smooth out the detected location and/or movements of a user and/or plurality of users may also have variations, as will be appreciated by those skilled in the art. As an example, some other embodiments include moving average smoothing, weighted moving average smoothing, autoregressive moving average smoothing, other types of smoothing, a combination thereof, or no smoothing.

In another alternative embodiment, various types of motors and actuators are utilized to articulate fan head location, direction, and the like. In one arrangement, a stepper motor for precise control is utilized. However, a direct current motor, a linear actuator, or other motor might be used.

In one arrangement, as is shown, a planetary gearbox is connected to the output motor. In this way, the planetary gearbox increases the torque of the motor and/or can be utilized to increase the torque of the motor. However, other embodiments utilize various types of motors which offer mechanical advantages and/or various parts and/or components which improve performance such as gears, levers, pulleys and the like. For this reason, various motor types, motors, power supplies, fan types, and the like are hereby contemplated for use. In some embodiments, no motor is needed to cause airflow but instead various types of airflow devices can be used.

In one arrangement, as is shown, limit switches are utilized for some purposes. However, in an alternative embodiment, other sensors such as rotary encoders, linear encoders, angle encoders, or force sensors, a combination thereof, and the like are used to detect and/or limit the rotation of the fan and/or fan head and/or airflow and/or airflow direction.

In the arrangement shown, as one example, various rules and/or settings are presented for user tracking. In this way, a user can select various settings for user tracking and/or tracking a plurality of users, as desired. The present disclosure also includes some alternative embodiments for tracking a user and/or a plurality of a user. These alternative embodiments includes, but are not limited to, tracking a first identified user, tracking an arbitrary person, recognizing and tracking a specific person based on appearance, tracking multiple users via oscillation, tracking multiple users via “turns” or timed intervals, a combination thereof and the like.

In addition to the above identified features, options, controls, and components, system 10 may also include other features and functionalities, among other options, controls, and components.

In Operation:

In one example, a user and/or plurality of users may implement one or more portable person tracking fan systems. In one method of use, a user first plugs in the fan to a power source and/or activates the power supply. A user then would select a fan speed. A user may then also select a mode. The system will then begin recording video and/or recording environmental data related to various parameters. The high resolution video and environmental data is then transmitted to the computing system The computing system may be onboard, but may also be a remote computing system.

In this way, once the data is transmitted to the computer, the computer executes a person tracking machine learning set of rules in real time to detect the locations of users, and particularly a single user is tracked. In this way, one setting may be that a person closest to the fan is the user which is tracked. In this way, the person which has a distance parameter of the least amount (as identified by a predetermined set of rules), would be tracked. Furthermore, the center person in the frame may be utilized with the predetermined set of rules to determine which person to track through video frames at predetermined intervals, and/or the person closest to the center of each video frame at varying rates.

Furthermore, in this operation of use, a person tracking includes machine learning. Machine learning can modify rules depending on the behavior of a user so that fan operation can be smoothed. This operation prevents jolting or rapid movements and regulates fan movements so that movement of the fan only occurs at desired intervals and/or times. Said another way, user movement may be jittery or jumpy or may appear this way on a camera, especially in circumstances where a human is working and has arm movements and the like. The machine learning and rules herein allow for modifications to the tracking depending on a user and the movements and behavior of a user so that camera movements are smooth and desired and only occur when desired.

Furthermore, and in this example of operation, an exponential smoothing set of rules is used for a smoothing factor constant. This constant is preprogrammed but can be modified as needed. This allows for smoothing through both horizontal and vertical positioning as may be determined through information gathered through the video and other data collected. This provides for frame by frame smoothing, which improves and enhances the operation of the fan movements.

In the arrangement shown, as one example, the operation utilizes a center mounted camera such that the center of the video frame corresponds to the air flow direction. However, other locations of video mounting, and corresponding understanding and computations of air flow direction are hereby contemplated for use. For example, a camera may be mounted remotely and separately from a fan and/or airflow. In this way, a fan may be mounted in a room corner or the like while a camera is located at a different location.

In the arrangement shown, as one example, where the operation utilizes a center mounted camera, the computer platform processors predict a location of a user and track that location frame by frame. Furthermore, the movements of a user can be predicted due to the frame by frame nature of data capture. In the operation, pixels and/or pixel measurements can be utilized to track distance a user is moving and differentiate between working movements and walking and/or other movements of a user. Said another way, the horizontal measurements and/or vertical measurements which correspond to movement of a user in distance can then be used to cause the fan to move in proportion to the distance moved of a user. Furthermore, these similar measurements can be used to change fan speed and/or cubic feet of air movement, and the like. The entire width of the camera frame may also be used for proportionality reasons. These and other parameters are also included and hereby contemplated for use, including motor size, motor speed, variations in motor speed, camera resolution, camera frame size, camera direction, rotational and/or directional speeds and the like.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. A user tracking fan system, comprising:
a plurality of users;
a power supply;
a control system;
wherein the control system is a manual control system;
at least one airflow device;
wherein the airflow device causes an airstream;
a camera system;
the camera system having at least one camera;
wherein the at least one camera is configured to view a space;
wherein the at least one camera is positioned such that the at least one camera can record a plurality of video frames which show at least one of the plurality of users;
a tracking assembly;
an onboard computing system;
wherein the plurality of video frames are received in a processor of the onboard computing system;
wherein the plurality of video frames are analyzed by a predetermined set of rules of the processor of the onboard computing system;
wherein the processor of the onboard computing system provides an output instruction which is operably connected to the tracking assembly;
wherein the tracking assembly operates according to the output instruction in causing the airflow device to mechanically move and track a user in accordance with the predetermined set of rules of the processor.

2. The system of claim 1, further comprising:
wherein the power supply is electrical power provided by conductance through a power cord;
the fan assembly operably connected to the power cord.

3. The system of claim 1, further comprising:
wherein the power supply is a plurality of batteries.

4. The system of claim 1, further comprising:
wherein the airflow device is at least one fan;
wherein each of the at least one fan having a plurality of vanes situated around a central axis.

5. The system of claim 1, further comprising:
wherein the airflow device is at least one fan;
wherein each of the at least one fan having a plurality of vanes situated around a central axis;
wherein each of the at least one fan having a fan housing;
the fan housing extending a length from a first end to a second end;
the fan housing having a top and a bottom with opposing sides;
the fan housing having a plurality of vents;
the fan housing having a plurality of apertures;
the fan housing having a plurality of attachment features;
the fan housing have a plurality of manual control features.

6. The system of claim 1, further comprising:
wherein the airflow device is at least one fan;
wherein each of the at least one fan having a plurality of vanes situated around a central axis;
wherein each of the at least one fan having a fan housing;
the fan housing extending a length from a first end to a second end;
the fan housing having a top and a bottom with opposing sides;
the fan housing having a plurality of vents;
the fan housing having a plurality of apertures;
the fan housing having a plurality of attachment features;
the fan housing have a plurality of manual control features;
the plurality of manual control features being buttons.

7. The system of claim 1, further comprising:
wherein the airflow device is at least one fan;
wherein each of the at least one fan having a plurality of vanes situated around a central axis;
wherein each of the at least one fan having a fan housing;
the fan housing extending a length from a first end to a second end;
the fan housing having a top and a bottom with opposing sides;
the fan housing having a plurality of vents;
the fan housing having a plurality of apertures;
the fan housing having a plurality of attachment features;
the fan housing have a plurality of manual control features;
the plurality of manual control features being dials.

8. The system of claim 1, further comprising:
the camera system having a wire;
wherein the wire is operably connected to the onboard computing system;
the camera system having a camera wire clamp;
wherein the camera wire clamp secures the camera wire in place;
the camera system having a camera wire cover.

9. The system of claim 1, further comprising:
a sensor system;
the sensor system having a plurality of sensors;
wherein the plurality of sensors detect various parameters associated with an environment.

10. The system of claim 1, further comprising:
a remote computing system.

11. The system of claim 1, further comprising:
an application server.

12. The system of claim 1, further comprising:
a smart device;
wherein the smart device is used to control the operations of the system.

13. The system of claim 1, further comprising:
the tracking assembly having a motor housing;
the tracking assembly having a mount;
the tracking assembly having a motor;
the tracking assembly having a driver;
the tracking assembly having a gearbox;
the gearbox having a gearbox shaft;
the gearbox having a gearbox connector plate;
the gearbox having a plurality of gears;
the tracking assembly having a motor gear connector;
the tracking assembly having a motor gear shaft;
the tracking assembly having a spindle;
the tracking assembly having a plurality of limit switches;
wherein the plurality of limit switches includes an inside limit switch;
wherein the plurality of limit switches includes an outside limit switch;
wherein the plurality of limit switches restrains the airflow device from moving beyond an approximate point in the range of movement of the airflow device;
the tracking assembly having a plurality of limit switch bumpers;
the tracking assembly having a plurality of rotation arms;
the tracking assembly having a rotation pivot;
the tracking assembly having a fan head pivot;
the tracking assembly having a fan head connector;
the tracking assembly having a fan head bracket;
the tracking assembly having a processor mount;
the tracking assembly having a computer module;
the tracking assembly having a motor driver;
the tracking assembly having a fan interface;
the tracking assembly having a rotation output connector;
the tracking assembly having a vibration damper;
the tracking assembly having a plurality of attachment features.

14. The system of claim 1, further comprising:
a graphical user interface;
the graphical user interface having a control system;
the control system having a speed control feature;
the control system having a movement control feature;
the control system having a plurality of user tracking settings;
wherein the graphical user interface is interacted with to control the functionality and settings of the tracking assembly and user tracking operations.

15. The system of claim 1, further comprising:
wherein the at least one camera is a high resolution camera.

16. The system of claim 1, further comprising:
a fan assembly;
the fan assembly extending a length from a first end to a second end;
the fan assembly having a top and a bottom;
the fan assembly having a base;
the fan assembly having a plurality of supports;
the fan assembly having a case;
the fan assembly having a central axis.

17. A portable person tracking fan system, comprising:
a plurality of users;
a power supply;
a control system;
wherein the control system is a manual control system;
a fan assembly;
the fan assembly extending a length from a first end to a second end;
the fan assembly having a top and a bottom;
the fan assembly having a base;
the fan assembly having a plurality of supports;
the fan assembly having a case;
the fan assembly having a central axis.
at least one airflow device;
wherein the airflow device causes an airstream;
a camera system;
the camera system having at least one camera;
wherein the at least one camera is configured to view a space;
wherein the at least one camera is positioned such that the at least one camera can record a plurality of video frames which show at least one of the plurality of users;
a tracking assembly;
an onboard computing system;
an onboard control system;
wherein the plurality of video frames are received in a processor of the onboard computing system;
wherein the plurality of video frames are analyzed by a predetermined set of rules of the processor of the onboard computing system;
wherein the processor of the onboard computing system provides an output instruction which is operably connected to the tracking assembly;
wherein the tracking assembly operates according to the output instruction in causing the airflow device to mechanically move and track a user in accordance with the predetermined set of rules of the processor;
a graphical user interface;
wherein the predetermined set of rules can be changed by one of the plurality of users through the graphical user interface;
wherein the predetermined set of rules can be autonomously updated by the processor through machine learning processes.

18. The system of claim 17, further comprising:
the onboard control system being a touchscreen;
the tracking assembly having a motor housing;
the tracking assembly having a mount;
the tracking assembly having a motor;
the tracking assembly having a driver;
the tracking assembly having a gearbox;
the gearbox having a gearbox shaft;
the gearbox having a gearbox connector plate;
the gearbox having a plurality of gears;
the tracking assembly having a motor gear connector;
the tracking assembly having a motor gear shaft;
the tracking assembly having a spindle;
the tracking assembly having a plurality of limit switches;
wherein the plurality of limit switches includes an inside limit switch;
wherein the plurality of limit switches includes an outside limit switch;
wherein the plurality of limit switches restrains the airflow device from moving beyond an approximate point in the range of movement of the airflow device;
the tracking assembly having a plurality of limit switch bumpers;
the tracking assembly having a plurality of rotation arms;
the tracking assembly having a rotation pivot;
the tracking assembly having a fan head pivot;
the tracking assembly having a fan head connector;
the tracking assembly having a fan head bracket;
the tracking assembly having a processor mount;
the tracking assembly having a computer module;
the tracking assembly having a motor driver;
the tracking assembly having a fan interface;
the tracking assembly having a rotation output connector;
the tracking assembly having a vibration damper;
the tracking assembly having a plurality of attachment features.

19. The system of claim 17, further comprising:
wherein the airflow device is at least one fan;
wherein each of the at least one fan having a plurality of vanes situated around a central axis;
wherein each of the at least one fan having a fan housing;
the fan housing extending a length from a first end to a second end;
the fan housing having a top and a bottom with opposing sides;
the fan housing having a plurality of vents;
the fan housing having a plurality of apertures;
the fan housing having a plurality of attachment features;
the fan housing have a plurality of control features.

20. A method of tracking a user and keeping a user cool with airflow, the steps comprising:
providing a airflow device; wherein the airflow device is a fan which causes an airstream;
providing a control system for turning the fan on and off;
providing an onboard computing system;
providing a high resolution video camera;
viewing an environment with the high resolution video camera;
detecting a plurality of users in an environment;
processing frames to determine user movement in the environment;
determining which user in an environment is closest to the airflow device by analyzing the video frames recorded;
smoothing the video frames to adjust tracking and predict the user's movement direction; calculate pixel counts in frame to frame changes to calculate operational fan movements causing the airstream to continue to be directed to the user.
